(19) United States
(12) Patent Application Publication
(10) Pub. No.: US 2005/0116797 A1
(43) Pub. Date: Jun. 2, 2005

(54) Electronically tunable block filter

(76) Inventors: Khosro Shamsaifar, Ellicott City, MD (US); Qinghua Kang, Newark, DE (US)

Correspondence Address: William J. Tucker, 14431 Goliad Dr. Box #8, Malakoff, TX, 75148, US

(21) Appl. No.: 10/748,757

(22) Filed: Dec. 30, 2003

Related U.S. Application Data
(60) Provisional application No. 60/445,345, filed on Feb. 5, 2003.

(51) Int. Cl. H01P 1/205

(52) U.S. Cl. 333/207

(57) ABSTRACT

A voltage-controlled tunable filter which includes a plurality of coaxial combline resonators and wherein at least one of said plurality of coaxial combline resonators includes at least one metallized through-hole. The coupling between adjacent resonators is obtained via an aperture formed on a common wall between the resonators, and is controlled by the aperture size and position. An input/output coupling metallization on at least one surface of said plurality of coaxial combline resonators is included as well as at least one tunable varactor associated with said plurality of coaxial combline resonators. An iris connects said plurality of coaxial combline resonators. The tunable dielectric capacitors can include a substrate having a low dielectric constant with planar surfaces and the substrate can be include a tunable dielectric film of low loss tunable dielectric material. The input/output coupling metallization can be metallized with a predetermined length, width, and gap distance and low loss isolation material can be used to isolate the outer bias metallic contact and the metallic electrode on the tunable dielectric.

### CROSS-REFERENCE TO RELATED APPLICATION

This application claims priority to U.S. Provisional Patent Application Ser. No. 60/445,345, “ELECTRONICALLY TUNABLE BLOCK FILTER” filed Feb. 5, 2003, by Khosro Shamsaifar.

### BACKGROUND OF THE INVENTION

The present invention generally relates to tunable filters, tunable dielectric capacitors, and MEM Varactors.

Electrically tunable microwave filters have found a wide range of applications in microwave systems. Compared to mechanically and magnetically tunable filters, electronically tunable filters have a very important advantage of having a fast tuning capability over wide frequency band applications. Because of this advantage, they can be used in the applications such as LMDS (local multipoint distribution service), cellular, PCS (personal communication system), frequency hopping, satellite communication, and radar systems. In the electronically tunable filters, filters can be divided into two types: 1) voltage-controlled tunable dielectric capacitor based tunable filters; and 2) semiconductor varactor based tunable filters. Compared to semiconductor varactor based tunable filters, tunable dielectric capacitor based tunable filters have the merits of lower loss, higher power-handling, and higher IP3, especially at higher frequencies (>1 OGHz).

Tunable filters have been developed by Paratek Microwave, Inc., the assignee of the present invention, for microwave radio applications. They are tuned electronically using dielectric varactors. Tunable filters offer service providers flexibility and scalability not previously possible. A single tunable filter solution enables radio manufacturers to replace several fixed filters needed to cover a given frequency band. This versatility provides front end RF tunability in real time applications and decreases deployment and maintenance costs through software control and reduced component count. Also, fixed filters need to be wide band so that their count does not exceed reasonable numbers to cover the desired frequency plan. Tunable filters, however, are narrow band, and maybe tuned in the field by remote command.

Additionally, narrowband filters at the front end are appreciated from the systems point of view, because they provide better selectivity and help reduce interference from nearby transmitters. Two of such filters can be combined in a diplexer or duplexer configuration.

Inherent in every tunable filter is the ability to rapidly tune the response using high-impedance control lines. Parascan®, the trademarked name for tunable materials technology developed by the assignee of the present invention, enables these tuning properties, as well as, high Q values, low losses and extremely high IP3 characteristics, even at high frequencies. MEMS based varactors can also be used for this purpose. They use different bias voltages to vary the electrostatic force between two parallel plates of the varactor and hence change its capacitance value. They show lower Q than dielectric varactors, and have worse power handling, but can be used successfully for some applications. Also, diode varactors could be used to make tunable filters, although with worse performance than with dielectric varactors.

Therefore, a strong need in the industry exists for RF filters that can reduce complexity by replacing multiple filters and switch assemblies with a single tunable filter that can tune its center frequency over multiple bands. Ultimately, it is desirable for several of these tunable filters to be integrated into a larger module to produce even further reduction of size.

### SUMMARY OF THE INVENTION

The present invention provides a voltage-controlled tunable filter which includes a plurality of coaxial combline resonators and wherein at least one of said plurality of coaxial combline resonators includes at least one metallized through-hole. The coupling between adjacent resonators is obtained via an aperture formed on a common wall between the resonators, and is controlled by the aperture size and position.

The present invention further includes an input/output coupling metallization on at least one surface of said plurality of coaxial combline resonators and at least one tunable varactor associated with said plurality of coaxial combline resonators and an iris connecting said plurality of coaxial combline resonators. The present invention can further include at least one DC biasing point for providing voltage to said at least one tunable varactor.

The tunable varactors can include a substrate having a low dielectric constant with planar surfaces and the substrate can include a tunable dielectric film of low loss tunable dielectric material. The input/output coupling metallization can be metallized with a predetermined length, width, and gap distance and low loss isolation material can be used to isolate the outer bias metallic contact and the metallic electrode on the tunable dielectric.

In an alternate embodiment, the tunable varactors are MEM tunable varactors which utilize either a parallel plate or interdigital topology.

The present invention also provides for a method of using voltage to control a tunable filter. The method comprises the steps of providing a plurality of coaxial combline resonators which include at least one metallized through-hole and an input/output coupling metallization on at least one surface of said plurality of coaxial combline resonators, then varying the capacitance of a capacitor by using at least one tunable capacitor associated with said at least one coaxial combline resonator and finally connecting said plurality of coaxial combline resonators with an iris.

The method can further include the step of providing voltage to said at least one tunable varactor with at least one DC biasing point and the step of controlling the coupling between adjacent resonators by controlling the aperture size and position of the iris formed on a common wall between the resonators. In this method the tunable dielectric capacitors can include a substrate having a low dielectric constant with planar surfaces and wherein the substrate further includes a tunable dielectric film on the substrate comprising of low loss tunable dielectric material. The input/output coupling metallization can be metallized with a predetermined length, width, and gap distance in this method and a low loss isolation material can be used to isolate the outer bias metallic contact and the metallic electrode on the tunable dielectric. As above, the tunable capacitors can be MEM tunable capacitors with either a parallel plate or interdigital topology.

### BRIEF DESCRIPTION OF THE DRAWINGS

FIG. 1 shows a front and back view of a two pole coaxial combline filter;

FIG. 2 shows a two pole coaxial combline tunable filter;

FIG. 3 shows the two pole response with no bias; and

FIG. 4 shows the two pole response under bias.

### DESCRIPTION OF THE PREFERRED EMBODIMENT

It is an object of the present invention to provide a voltage-tuned filter having low insertion loss, fast tuning speed, high power-handling capability, high IP3 and low cost in the microwave frequency range. Compared to MEMS varactors or voltage-controlled semiconductor varactors, voltage-controlled tunable capacitors have higher Q factors, higher power-handling and higher IP3. Voltage-controlled tunable dielectric capacitors and MEM varactors can be employed in the filter structure of the present invention to facilitate this.

The present invention is an electronically tunable filter made in dielectric block. The tuning elements are voltage-controlled tunable dielectric capacitors placed on the ceramic block. Alternatively, MEMS varactors or diode varactors can be used to make tunable filters, although with limited applications. Since the tunable capacitors show high Q, high IP3 (low inter-modulation distortion) and low cost, the tunable filter in the present invention has the advantage of low insertion loss, fast tuning speed, and high power handling. The present technology makes tunable filters very promising in the contemporary communication system applications.

The tunable dielectric capacitor in the present invention is made from low loss tunable dielectric film. The range of Q factor of the tunable dielectric capacitor is between 50, for very high tuning material, and 300 or higher, for low tuning material. It also decreases with increasing the frequency, but even at higher frequencies say 30 GHz can take values as high as 100. A wide range of capacitance of the tunable dielectric capacitors is available, from 0.1 pF to several pF. The tunable dielectric capacitor is a packaged two-port component, in which a tunable dielectric can be voltage-controlled. The tunable film is deposited on a substrate, such as MgO, LaAIO3, sapphire, Aha3 or other dielectric substrates. An applied voltage produces an electric field across the tunable dielectric capacitor which produces an overall change in the capacitance of the tunable dielectric. Furtherer examples of tunable dielectric capacitors and their fabrication and uses are fully set forth in commonly owned, co-pending application Ser. No. 09/734,969, filed Dec. 12, 2000, entitled “ELECTRONICLY TUNABLE FILTERS WITH DIELECTRIC VARACTORS”, to Yongfei Zhu et al. This patent application is incorporated in by reference.

The tunable capacitors with microelectromachanical technology can also be used in the tunable filter and are part of this invention. At least two varactor topologies can be used, parallel plate and interdigital. In the parallel plate structure, one of the plates is suspended at a distance from the other plate by suspension springs. This distance can vary in response to electrostatic force between two parallel plates induced by applied bias voltage. In the interdigital configuration, the effective area of the capacitor is varied by moving the fingers comprising the capacitor in and out and changing its capacitance value. MEM varactors have lower Q than their dielectric counterpart, especially at higher frequencies, and have worse power handling, but can be used in certain applications.

The tunable block filter consists of a ceramic block with metallization in some areas to form a coaxial combline structure. Elaboration on applying metallization to ceramic blocks is set forth in a commonly owned, co-pending patent application entitled, “METHOD OF APPLYING PATTERNED METALLIZATION TO BLOCK FILTER RESONATORS”, serial number TBD, filed on Dec. 15, 2003 to Mohammed Mahbubur Rahman. This patent application is incorporated in by reference.

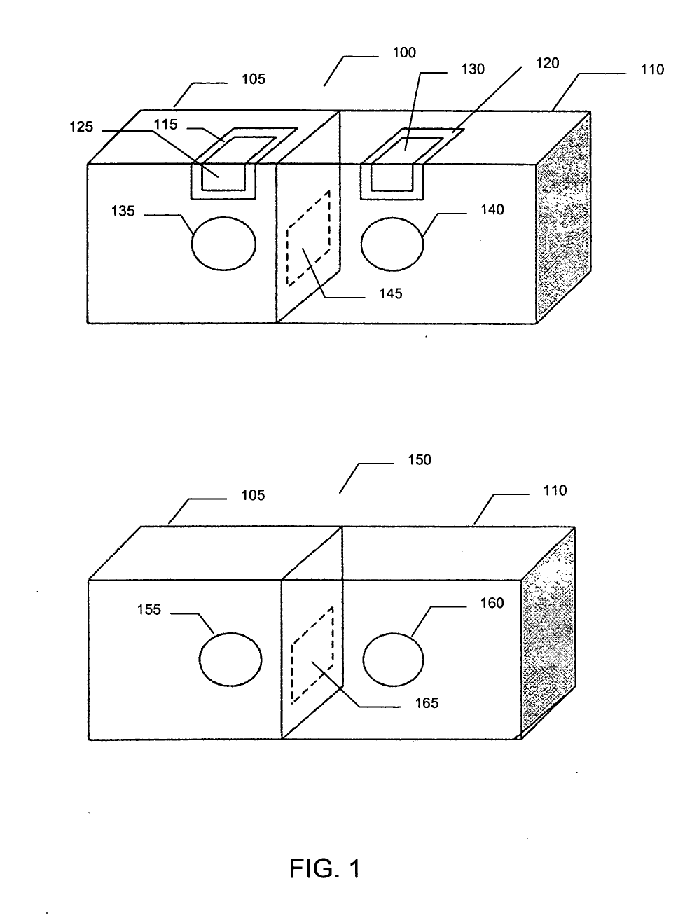

The various features of the present invention will now be described with respect to the figures. FIG. 1 illustrates a two-pole filter shown generally as 100. It consists of two coaxial combline resonators 105 and 110 coupled to each other through an iris 145. The coaxial block configuration is one in which each block resonator possesses a quarter-wavelength coaxial transmission line form with one end shorted. The coupling between adjacent resonators is obtained via the aperture in iris 145 formed on the common wall between the resonators 105 and 110, and is controlled by the aperture size and position. One end of the resonator 105 and 110 is open and the other end is short. The coaxial cavities 135 and 140 forming the resonators are filled with high dielectric constant material to reduce the size, which makes it ideal for Handset phone applications. The access coupling to the resonators is achieved by probes 125 and 130 which consist of metallizing part of the dielectric at the open end of the resonators 105 and 110. All other surfaces are metalized ground. The input/output coupling metalization has been extended to the perpendicular surface and isolated as shown at 115 and 120 for SMD applications.

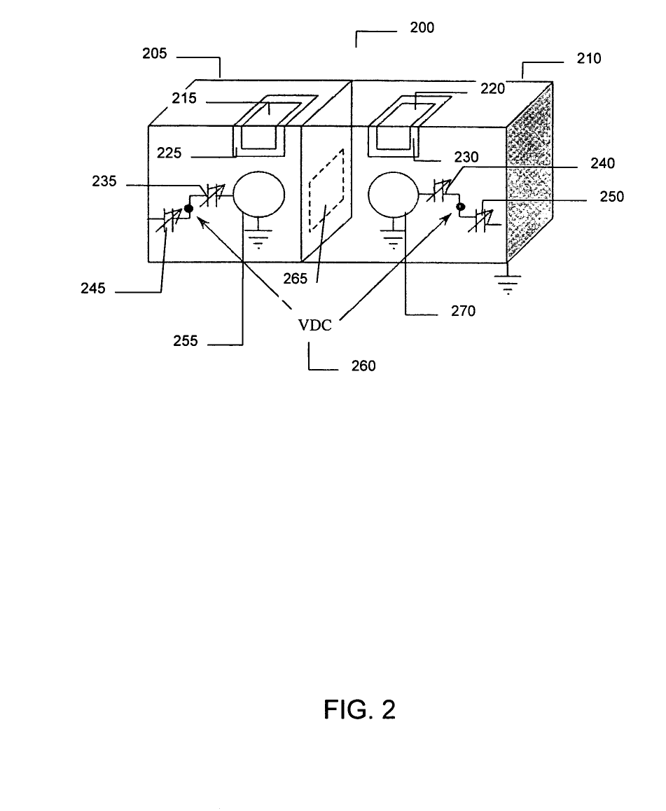

FIG. 2 depicts the addition of tunability to this filter, which is shown generally as 200. One, two or more tunable varactors 235, 240, 245 and 250 will be placed near the open end of the resonators 205 and 210. Filters with higher number of poles will be made by simply adding more resonators between the two shown in the FIG. 2. As with FIG. 1, the filter of FIG. 2 consists of two coaxial combline resonators 205 and 210 coupled to each other thru an iris 265. Again, the coaxial block configuration is one in which each block resonator 205 and 210 possesses a quarter-wavelength coaxial transmission line form with one end shorted. The coupling between adjacent resonators is obtained via the aperture in iris 265 formed on the common wall between the resonators 205 and 210, and is controlled by the aperture size and position. One end of the resonator 205 and 210 is open and the other end is short. The coaxial cavities 255 and 270 forming the resonators, are filled with high dielectric constant material to reduce the size. The access coupling to the resonators is achieved by probes 215 and 220 which consist of a metallizing part of the dielectric at the open end of the resonators 205 and 210. All other surfaces are metalized ground. The input/output coupling metalization has been extended to the perpendicular surface and isolated as shown at 125 and 230 for SMD applications.

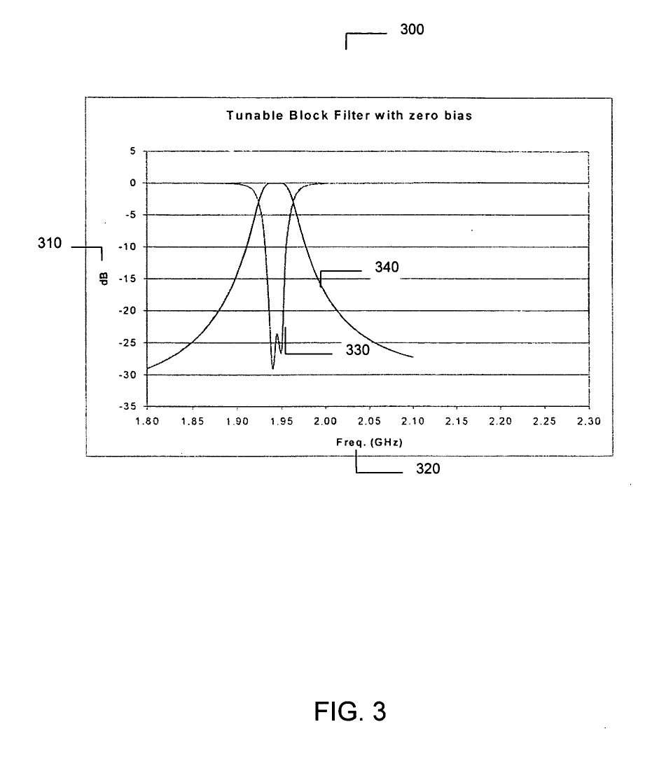

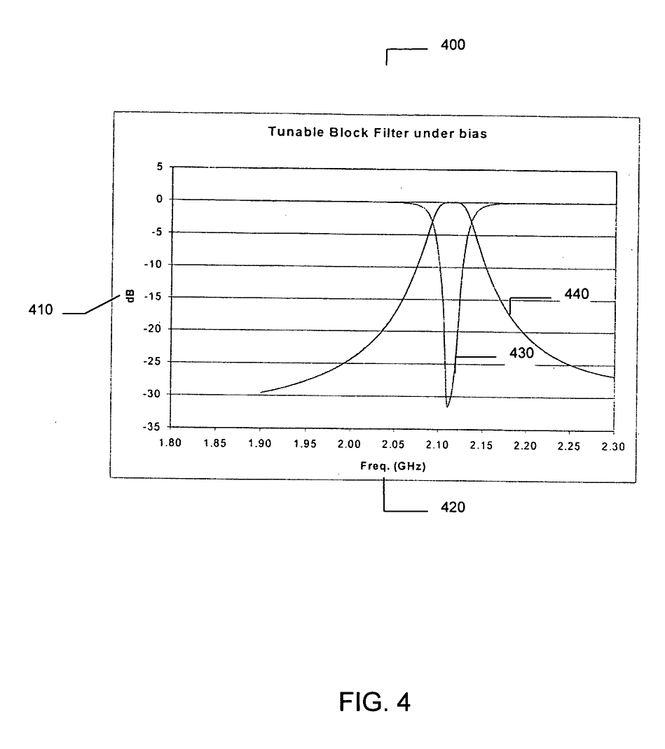

The response of a two-pole filter is presented in FIG. 3 at 300 with no bias. The response in dB 310 vs. Ghz 320 is shown by lines 330 and 340. The same response under bias voltage is shown in FIG. 4 at 400. Again, the response is in dB 410 vs. Ghz 420 and shown by lines 430 and 440. It is clear from these two graphs the shift to the right and tunablity of the present invention.

The varactors will be biased by a bias circuit (not shown herein, but depicted in the patent applications incorporated in by reference). This bias circuit could be implemented on the board where this SMD block filter would be mounted. The input/output coupling to the filter is shown in the figures as capacitive coupling, but it could also be inductive. Also, coaxial probes with connectors could be used. Examples of input/ouput coupling which is both capacitive and inductive is fully set forth in commonly owned, co-pending application serial number TBD, filed Dec. 19, 2003, entitled “ELECTRONICALLY TUNABLE BLOCK FILTER WITH TUNABLE TRANSMISSION ZEROS”, to Qinghua Kang et al. This patent application is incorporated in by reference.

While various embodiments of the present invention have been described above, it should be understood that they have been presented by way of example, and not limitation. It will be apparent to persons skilled in the relevant art that various changes in form and detail can be made therein without departing from the spirit and scope of the invention.

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed. Any such alternate boundaries are thus within the scope and spirit of the claimed invention. Thus, the breadth and scope of the present invention should not be limited by any of the above-described exemplary embodiments, but should be defined only in accordance with the following claims and their equivalents.

All cited patent documents and publications in the above description are incorporated herein by reference.

1. A voltage-controlled tunable filter, comprising:
a plurality of coaxial combline resonators;
at least one of said plurality of coaxial combline resonators includes and at least one metallized through-hole;
an input/output coupling metallization on at least one surface of said plurality of coaxial combline resonators;
at least one tunable varactor associated with said plurality of coaxial combline resonators; and
an iris connecting said plurality of coaxial combline resonators.

2. The voltage-controlled tunable filter of claim 1, further comprising at least one DC biasing point for providing voltage to said at least one tunable varactor.

3. The voltage-controlled tunable filter of claim 1, wherein coupling between adjacent resonators is obtained via the aperture formed on a common wall between the resonators, and is controlled by the aperture size and position.

4. The voltage-controlled tunable filter of claim 1, wherein said at least one input/output coupling metallization on at least one surface of said at least one coaxial combline resonator is two input/output coupling metallizations on at least one surface of said at least one coaxial combline resonator.

5. The voltage-controlled tunable filter of claim 1, wherein said voltage-controlled tunable filter is a coaxial block voltage controlled tunable filter.

6. The voltage-controlled tunable filter of claim 1, wherein said tunable varactors include a substrate having a low dielectric constant with planar surfaces.

7. The voltage-controlled tunable filter of claim 6, wherein said substrate further includes a tunable dielectric film on the substrate comprising a low loss tunable dielectric material.

8. The voltage-controlled tunable filter of claim 1, wherein said input/output coupling metallization is metallized with a predetermined length, width, and gap distance and wherein a low loss isolation material is used to isolate the outer bias metallic contact and the metallic electrode on the tunable dielectric.

9. The voltage-controlled tunable filter of claim 1, wherein said tunable varactors are MEM tunable capacitors.

10. The voltage-controlled tunable filter of claim 9, wherein said MEM tunable capacitor utilizes a parallel plate topology.

11. The voltage-controlled tunable filter of claim 1, wherein said MEM tunable capacitor utilizes an interdigital topology.

12. A method of using voltage to control a tunable filter, comprising the steps of:
providing a plurality of coaxial combline resonators;
said plurality of coaxial combline resonators include at least one metallized through-hole and an input/output coupling metallization on at least one surface of said plurality of coaxial combline resonators;
varying the capacitance of a capacitor by using at least one tunable capacitor associated with said at least one coaxial combline resonator; and
connecting said plurality of coaxial combline resonators with an iris.

13. The method of using voltage to control a tunable filter of claim 12, further comprising the step of providing voltage to said at least one tunable varactor with at least one DC biasing point.

14. The method of using voltage to control a tunable filter of claim 12, further comprising the step of controlling the coupling between adjacent resonators by controlling the aperture size and position of said iris formed on a common wall between the resonators.

15. The method of using voltage to control a tunable filter of claim 12, wherein said at least one input/output coupling metallization on at least one surface of said at least one coaxial combline resonator is two input/output coupling metallizations on at least one surface of two coaxial combline resonators.

14. The method of using voltage to control a tunable filter of claim 12, wherein said voltage-controlled tunable filter is a coaxial block voltage controlled tunable filter.

15. The method of using voltage to control a tunable filter of claim 12, wherein said tunable dielectric capacitors include a substrate having a low dielectric constant with planar surfaces.

16. The method of using voltage to control a tunable filter of claim 15, wherein said substrate further includes a tunable dielectric film on the substrate comprising low loss tunable dielectric material.

17. The method of using voltage to control a tunable filter of claim 12, wherein said input/output coupling metallization is metallized with a predetermined length, width, and gap distance and wherein a low loss isolation material is used to isolate the outer bias metallic contact and the metallic electrode on the tunable dielectric.

18. The method of using voltage to control a tunable filter of claim 12, wherein said tunable varactors are MEM tunable varactors.

19. The method of using voltage to control a tunable filter of claim 12, wherein said MEM tunable varactor utilizes a parallel plate topology.

20. The method of using voltage to control a tunable filter of claim 12, wherein said MEM tunable varactor utilizes an interdigital topology.
